(19) United States
(12) Patent Application Publication
(10) Pub. No.: US 2011/0051564 A1
(43) Pub. Date: Mar. 3, 2011

(54) Windup portable timepiece and method of operating crown with which this timepiece is equipped

(76) Inventors: Haruki Hiranuma, Chiba-shi (JP); Kazutaka Imai, Chiba-shi (JP)

(21) Appl. No.: 12/806,994

(22) Filed: Aug. 25, 2010

(30) Foreign Application Priority Data
Aug. 28, 2009 (JP) 2009-198711

(51) Int. Cl. G04B 3/00

(52) U.S. Cl. 368/147

(57) ABSTRACT

A portable timepiece has a timepiece exterior assembly having a case band containing a movement having a one-way clutch transmitting rotation to wind up a mainspring to the mainspring and preventing transmission of rotation to rewind the mainspring to the mainspring, and a winding stem, a winding stem pipe with a male screw portion arranged outside the case band being fixed to the case band, a crown connected to the winding stem being detachably brought into the male screw portion, an engagement end surface of the crown being brought into contact with a lock surface of the case band to maintain the crown in a lock state. The portable timepiece is characterized in that when placing the crown in the lock state, the crown is rotated in a direction opposite to the winding-up direction of the mainspring, and when releasing the lock state to wind up the mainspring, the crown is rotated in the same direction as the mainspring winding-up direction.

### FIELD OF THE INVENTION

The present invention relates to a portable timepiece such as a windup diver's watch equipped with a crown locked so as to prevent inadvertent rotation while it is being carried about, and a method of operating the crown with which this timepiece is equipped.

### BACKGROUND OF THE INVENTION

There is conventionally known a portable timepiece equipped with a lock structure to prevent inadvertent rotation of a crown through utilization of mesh engagement of gear portions (See, for example, JP-A-2005-127816 (paragraphs 0011-0055 and FIGS. 1 through 5)).

In this conventional lock structure, the crown is equipped with a crown shaft interlocked with a winding stem, and a crown head for rotating this shaft. A shaft end portion of the crown shaft is arranged outside a winding stem pipe fixed to a case band containing a movement. At the same time, an odd-form torque receiving portion is formed in the periphery of the shaft end portion, and a crown head is provided with a female screw portion and an odd-form torque transmitting portion. The torque transmitting portion is of a larger diameter than the female screw portion, and is formed so as to be continuous with the female screw portion. The torque transmitting portion is detachable with respect to the torque receiving portion, and the torque transmitting portion and the torque receiving portion constitute a kind of dog clutch serving to effect the transmission of power or the releasing thereof between the crown head and the crown shaft.

In this portable timepiece, a male screw portion of the winding stem pipe is situated outside the case band, and the female screw portion of the crown is detachably in mesh with this male screw portion. Through this mesh engagement, there is attained a lock state in which an engagement end surface of the crown is held in contact with a lock surface formed on the outer peripheral portion of the case band, whereby it is possible to maintain the crown free from inadvertent rotation. In the state in which the crown is thus locked, the torque transmitting portion is spaced apart from the torque receiving portion, and the dog clutch is in a state in which the transmission of torque is off.

In the state in which the female screw portion and the male screw portion have been placed out of mesh engagement with each other, that is, in the state in which the lock state of the crown has been released, the crown head is moved away from the case band by the urging force of an elastic member. As a result of this movement, the torque transmitting portion is fit-engaged with the torque receiving portion, and the dog clutch is engaged and placed in a state in which the transmission of torque is possible. Thus, when the crown head is rotated with the lock released, rotation is transmitted via the torque transmitting portion and the torque receiving portion fit-engaged with each other to the crown shaft, making it possible to rotate the winding stem.

### SUMMARY OF THE INVENTION

In the portable timepiece of Patent Document 1, when performing the rotating operation to mesh-engage the female screw portion of the crown head with the male screw portion of the pipe to place the crown in the lock state, there is no fear of the winding stem being rotated in synchronization therewith. Thus, in the case of a windup portable timepiece whose movement has a mainspring as the power source thereof, it is advantageously possible to lighten the operation of locking the crown without being affected by the mainspring.

However, when releasing the lock state of the crown, between the moment that the mesh engagement of the female screw portion and the male screw portion is released and the moment that the torque transmitting portion is engaged with the torque receiving portion, the crown head is not supported, and there is a possibility of its becoming loose. Thus, the operation of the crown becomes rather unstable, and the torque transmitting portion may be incapable of being smoothly engaged with the torque receiving portion. That is, in some cases, it is impossible to attain satisfactory operability in placing the dog clutch composed of the torque transmitting portion and the torque receiving portion in the “engaged (connected)” state.

Further, in Patent Document 1, there is no description regarding the rotating direction of the crown when the mainspring is wound up, and the rotating direction of the crown when the lock state is released. Generally speaking, however, the winding-up of the mainspring is effected by rotating the crown to the right (clockwise). On the other hand, to release the engagement of the male screw portion and the female screw portion, the crown is rotated to the left (counterclockwise).

Thus, to release the lock state of the crown, and then wind up the mainspring, it is necessary to first rotate the crown to the left to release the lock state of the crown, and then rotate the crown to the right to wind up the mainspring. In these procedures, it is necessary to check as to whether the lock of the crown has been released or not; further, based on this checking, the crown is rotated in the reverse direction, so that it is impossible to perform the series of procedures from the releasing of the lock state of the crown to the winding-up of the mainspring through an operation similar to a one-stroke operation, resulting in a rather poor operability.

It is an object of the present invention to provide a windup portable timepiece in which it is possible to improve the operability of the crown when placing the crown in a lock state and when releasing the lock state of the crown to wind up the mainspring, and a method of operating the crown with which this timepiece is equipped.

To solve the above problem, there is provided, according to the present invention, a portable timepiece comprising: a movement having a mainspring, and a one-way clutch which transmits rotation to wind up this mainspring to the mainspring and which operates so as to prevent rotation to rewind the mainspring from being transmitted to the mainspring; a winding stem transmitting rotation to this movement; a timepiece exterior assembly having a case band with a lock surface formed in an outer peripheral portion thereof and containing the movement and the winding stem; a winding stem pipe having a male screw portion arranged outside the case band and fixed to the case band; and a crown which has a crown head arranged outside the case band, the crown head having a female screw portion detachably and threadedly engaged with the male screw portion and an engagement end surface moving toward and away from the lock surface, and which is rotated in a direction opposite to the direction in which the mainspring is wound up when bringing the engagement end surface into contact with the lock surface to maintain a lock state, and is rotated in the same direction as the direction in which the mainspring is wound up when releasing the lock state and winding up the mainspring.

In the present invention, although no dog clutch is provided in the crown, when placing the crown in the lock state, a state is attained in which the one-way clutch of the movement cuts off power transmission as the crown is rotated in a direction opposite to the direction in which the crown is rotated when winding up the mainspring. Thus, it is possible to place the crown in the lock state without receiving the winding-up load of the mainspring, and, if, at this time, the mainspring has been wound up, there is no fear of this mainspring being further wound up, so that the rotation of the crown when placing the crown in the lock state does not become heavy. Further, when the lock state of the crown is released and the mainspring is wound up, the direction in which the crown is rotated to release the lock state of the crown and the direction in which the crown is rotated to subsequently wind up the mainspring, are the same. Thus, it is possible to attain continuity in the rotating operation without having to mind the rotating direction of the crown, thereby making it possible to improve the operability of the crown.

A preferred mode of the portable timepiece of the present invention is characterized in that the male screw portion and the female screw portion are formed such that when the crown is rotated in a direction opposite to the direction in which the mainspring is wound up, the crown is moved so as to bring the engagement end surface into contact with the lock surface.

In this preferred mode, the male screw portion of the winding stem pipe and the female screw portion of the crown are held in mesh with each other, and the crown is rotated in a direction opposite to the direction in which the mainspring is wound up, whereby the crown is moved to the case band side and the engagement end surface thereof is brought into contact with the lock surface of the case band, thereby maintaining the crown in the lock state. At the same time, when the lock state is released and the mainspring is wound up, the crown is rotated in the same direction as the winding-up direction of the mainspring, so that, by forming the male screw portion and the female screw portion in conformity with the mainspring winding-up direction of the movement, it is possible to solve the problem of the present invention while adopting the same construction as that of the prior art for the remaining portions.

A preferred mode of the portable timepiece of the present invention is characterized in that the mainspring is wound up when the crown is rotated to the right, and that the crown is arranged in the lock state when the crown is rotated to the left.

In this preferred mode, to wind up the mainspring, the crown is rotated to the right, i.e., in the same crown rotating direction as generally adopted in the prior art, so that no sense of incongruity is involved in the operation of winding up the mainspring. At the same time, the lock state of the crown can be realized by rotating the crown to the left, so that, by forming the male screw portion and the female screw portion so as to enable them to rotate to the right and to the left, it is possible to solve the problem of the present invention while adopting the same construction as that of the prior art for the remaining portions.

A preferred mode of the portable timepiece of the present invention is characterized in that a sign indicating the rotating direction of the crown when placing the crown in the lock state is provided on a front side of a crown head.

In this preferred mode, by rotating the crown according to the sign on the crown head, it is possible to suppress an error in the crown rotating direction in placing the crown in the lock state.

In the method of operating the crown with which the portable timepiece of the present invention is equipped, there is adopted as a prerequisite a portable timepiece comprising: a movement having a mainspring, and a one-way clutch which transmits rotation to windup this mainspring to the mainspring and which operates so as to prevent rotation to rewind the mainspring from being transmitted to the mainspring; a winding stem transmitting rotation to this movement; a timepiece exterior assembly having a case band with a lock surface formed in an outer peripheral portion thereof and containing the winding stem; a winding stem pipe having a male screw portion arranged outside the case band and fixed to the case band; and a crown which has a crown head arranged outside the case band and having a female screw portion detachably and threadedly engaged with the male screw portion and an engagement end surface moving toward and away from the lock surface, and which is maintained in a lock state by bringing the engagement end surface into contact with the lock surface.

And, to solve the above problem, there is provided, according to the present invention, a method of operating a crown characterized in that, when placing the crown in the lock state, the crown is rotated in a direction opposite to the direction in which the mainspring is wound up, and that, when winding up the mainspring from the lock state, the crown is rotated in the same direction as the winding-up direction of the mainspring to release the lock, and continue, subsequent to this releasing, the rotation of the crown in the same direction.

In this crown operating method, in the operation of rotating the crown when placing the crown in the lock state, the one-way clutch cuts off power transmission as the crown is rotated in a direction opposite to the crown rotating direction when winding up the mainspring, so that it is possible to lock the crown without receiving the winding-up load of the mainspring; further, at this time, even if the mainspring has been wound up, there is no fear of this mainspring being further wound up, so that the crown rotating operation when locking the crown does not become heavy, thereby improving the operability of the crown. Further, when releasing the lock state of the crown and winding up the mainspring, the rotating direction of the crown when releasing the lock of the crown and the rotating direction for the subsequent winding-up of the mainspring are the same, and it is possible to achieve continuity in the rotating operation without having to mind the rotating direction of the crown, so that it is possible to improve the operability of the crown.

According to the present invention, it is possible to improve the operability of the crown when placing the crown in the lock state and when releasing the lock state of the crown to wind up the mainspring.

### BRIEF DESCRIPTION OF THE DRAWINGS

FIG. 1 is a front view of a windup wristwatch according to an embodiment of the present invention with the crown thereof locked.

FIG. 2 is a sectional view taken along the line F2-F2 of FIG. 1.

FIG. 3 is a front view of a wristwatch according to an embodiment with the lock of the crown thereof released.

FIG. 4 is a sectional view taken along the line F4-F4 of FIG. 3.

FIG. 5 is a side view of the portion of a wristwatch according to an embodiment around the crown thereof.

FIG. 6 is a perspective view showing a part of a movement with which a wristwatch according to an embodiment is equipped along with a winding stem.

FIG. 7 is a perspective view showing the portion of a movement with which a wristwatch according to an embodiment is equipped around a one-way clutch thereof.

FIG. 8 is a diagram showing the relationship between a movement barrel of a movement with which a wristwatch according to an embodiment is equipped and a mainspring accommodated therein prior to the winding-up of the mainspring.

FIG. 9 is a diagram showing the relationship between a movement barrel of a movement with which a wristwatch according to an embodiment is equipped and a mainspring accommodated therein with the mainspring wound up.

### DETAILED DESCRIPTION OF THE PREFERRED EMBODIMENTS

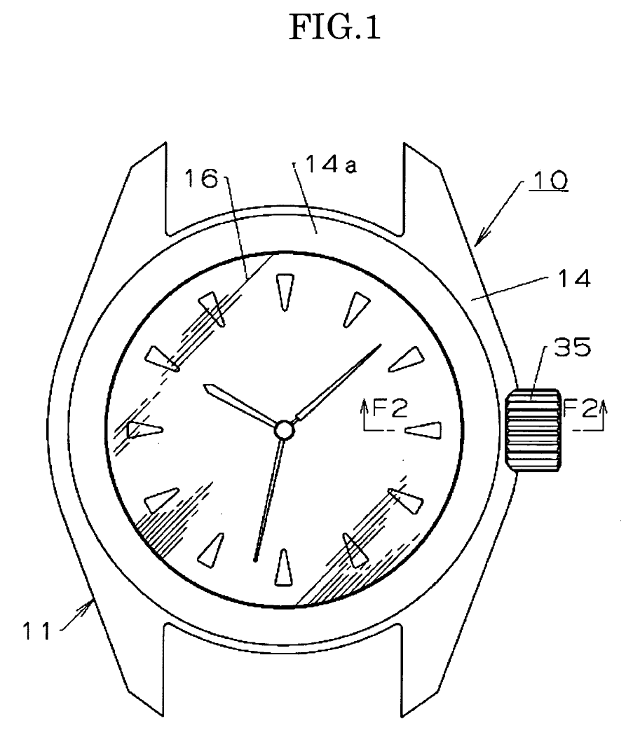

In the following, an embodiment of the present invention will be described in detail with reference to FIGS. 1 through 9.

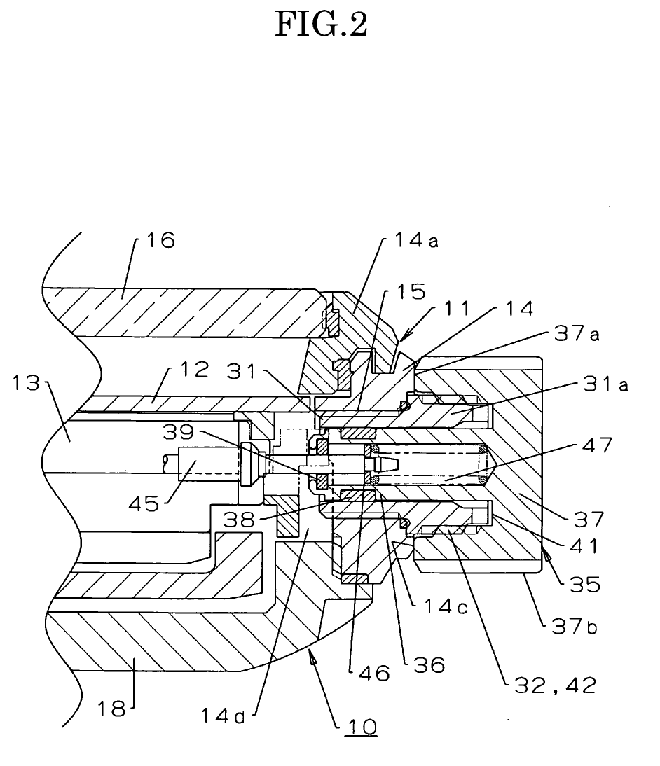

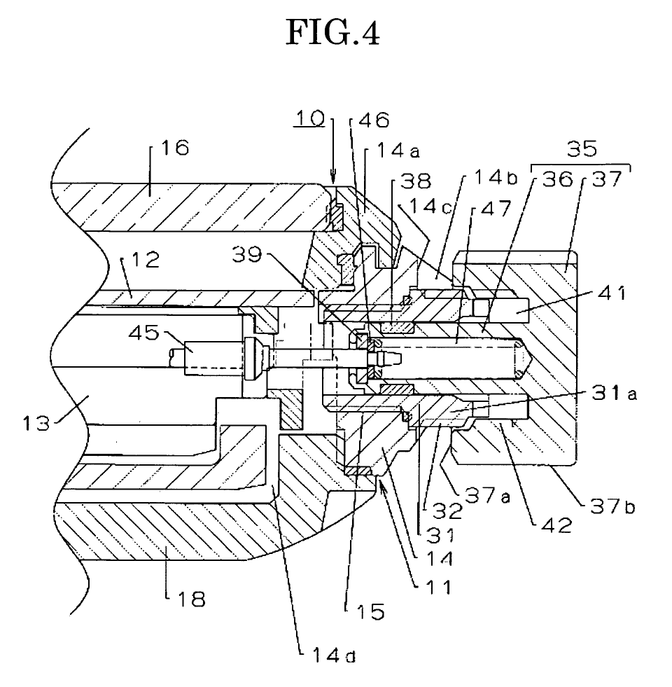

In FIGS. 1 through 4, numeral 10 indicates a windup portable timepiece such as a windup wristwatch. As shown in FIGS. 2 and 4, a timepiece exterior assembly 11 of the wristwatch 10 contains a time indication plate 12 and a movement 13, and, as shown in FIGS. 1 through 4, a crown 35 is mounted to the peripheral portion of the timepiece exterior assembly 11.

As shown in FIGS. 2 and 4, the timepiece exterior assembly 11 is equipped with a case band 14, a cover glass 16, and a case back 18. The case band 14 is formed of metal in an annular configuration. The case band 14 has a glass support member 14a attached to the front side thereof. The glass support member 14a is formed of metal in an annular configuration. Instead of being formed as separate members as described above, the glass support member 14a, and the portion of the case band 14 other than that, that is, the case band main portion, may also be formed integrally.

A groove 14b is formed in the outer peripheral portion of the case band 14, more specifically, in the outer peripheral portion of the case band main portion. The groove 14b is provided in correspondence with the time indication of 3 o'clock on the time indication plate 12, and is open on the front side, on the back side, and sideways in the timepiece exterior assembly 11. The case band 14 has a lock surface 14c parallel to the thickness direction thereof, and the lock surface 14c is formed by the bottom surface of the groove 14b.

The peripheral portion of the cover glass 16 is connected to the glass support member 14a in a liquid-tight fashion; it is attached thereto so as to cover the front side consisting of one surface in the thickness direction of the case band 14. The case back 18 is formed of metal or the like, and is threadedly attached to the case band 14 while covering in a liquid-tight fashion the back surface consisting of the other surface in the thickness direction of the case band 14.

The portion of the case band 14 other than the glass support member 14a, that is, the case band main portion, has a pipe mounting hole 15 extending radially through the case band 14. One end of the pipe mounting hole 15 is open to an in-case-band space 14d surrounded by the case band 14. The other end of the pipe mounting hole 15 is open to the lock surface 14c.

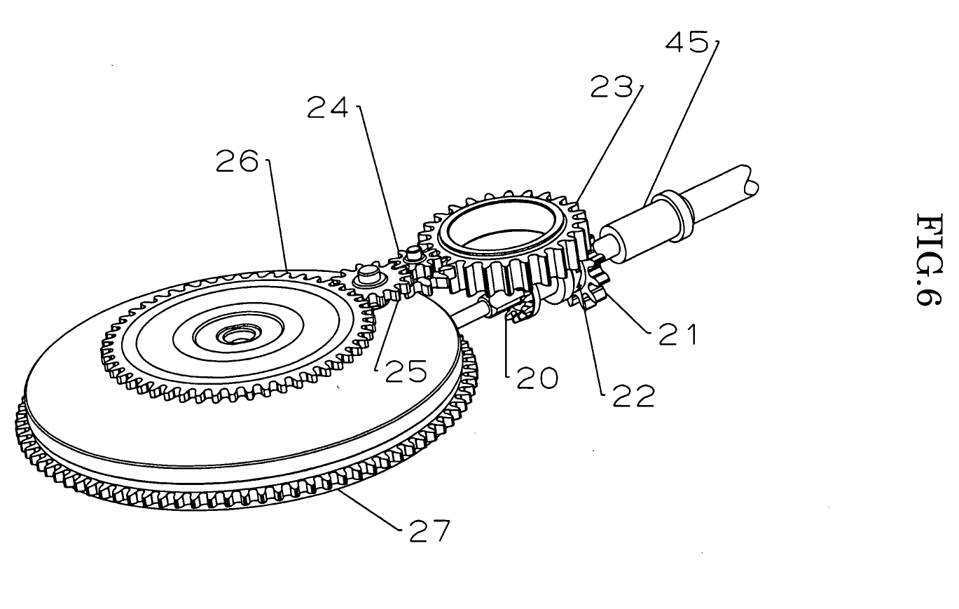

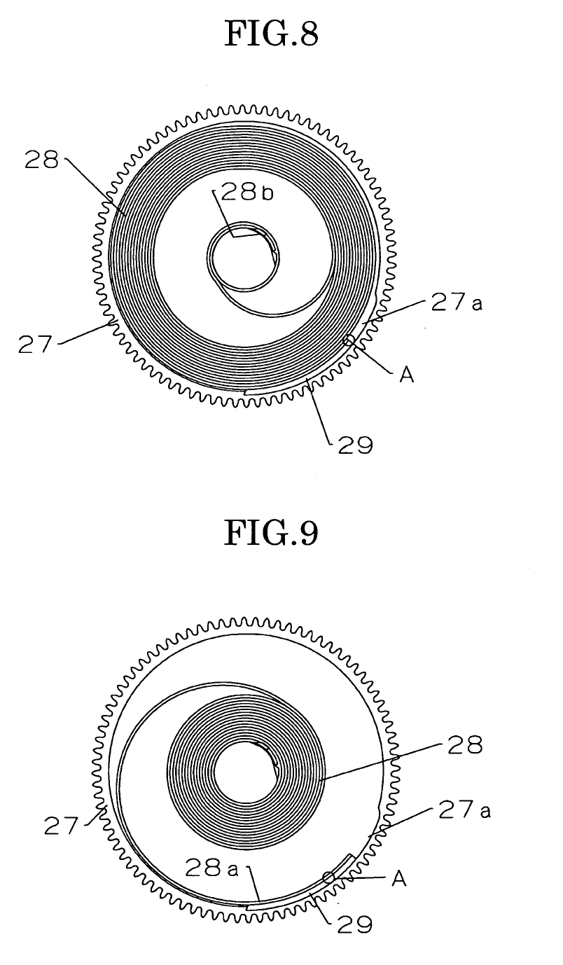

The movement 13 arranged in the in-case-band space 14d is of a mechanical type using as a power source a mainspring 28 (See FIGS. 8 and 9) wound up through manual operation of the crown 35. The movement 13 is, for example, of a general conventional type; as shown in FIG. 6, to wind up the mainspring 28, it is equipped with a clutch wheel 20, a winding pinion 21, a one-way clutch 22, a crown wheel 23, a crown operating wheel 24, a rock wheel 25, a ratchet wheel 26, a movement barrel 27, etc.

The clutch wheel 20 is connected to a winding stem 45 described below. The clutch wheel 20 has a square shaft portion (not shown), and this square shaft portion is inserted for connection into a square hole (not shown) of the winding stem 45. Thus, the clutch wheel 20 is rotated in synchronization with the rotation of the winding stem 45, and the winding stem 45 can move in the axial direction along the square shaft portion of the clutch wheel 20; through this movement, the winding stem 45 and the crown 35 are moved to the positions of “0th step,” “1st step,” and “2nd step.” At the position of the “1st step, ” the power transmission between the clutch wheel 20 and the winding pinion 21 is released, and the clutch wheel is connected to a calendar corrector wheel row (not shown); at the position of the “2nd step, ” it is connected to a time corrector wheel row (not shown).

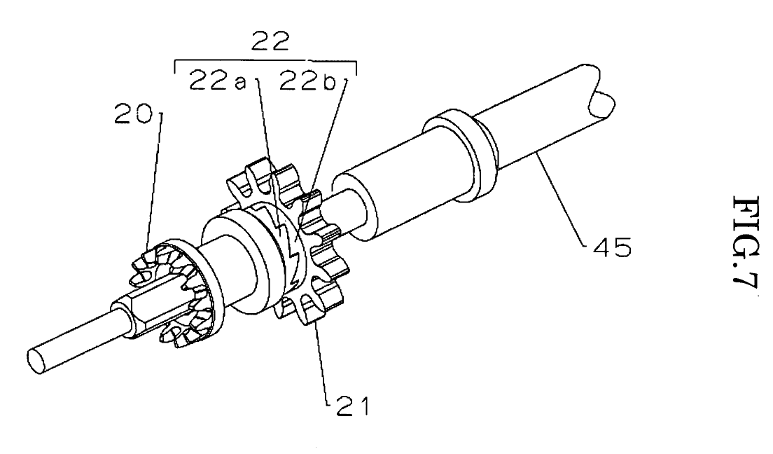

The outer periphery of the clutch wheel side end portion of the winding stem 45 is formed in a round configuration, and the winding pinion 21 is fit-engaged with this outer periphery so as to be rotatable and incapable of moving in the axial direction of the winding stem 45. The one-way clutch 22 serves to effect and release the power transmission between the clutch wheel 20 and the winding pinion 21; for example, as shown in FIG. 7, there is employed a dog clutch equipped with a pair of clutch members 22a, 22b having a plurality of claw portions with inclined surfaces. The clutch member 22a is formed integrally with the clutch wheel 20, and the clutch member 22b is formed integrally with the winding pinion 21 moved together with the winding stem 45. When the winding stem 45 is rotated to the right (clockwise), the one-way clutch 22 maintains the engagement of the clutch members 22a, 22b, and transmits power from the clutch wheel 20 to the winding pinion 21. Conversely, when the winding pinion 45 is rotated to the left (counterclockwise), the one-way clutch 22 releases the engagement of the clutch members 22a, 22b, releasing the transmission of power from the clutch wheel 20 to the winding pinion 21.

As shown in FIG. 6, the crown wheel 23 is arranged so as to be perpendicular to the winding pinion 21, and is in mesh with the winding pinion 21. The crown operating wheel 24 is in mesh with the crown wheel 23, and the rock wheel 25 is in mesh with the crown operating wheel 24. Further, the ratchet wheel 26 is in mesh with the rock wheel 25. The ratchet wheel 26 is provided on a side surface of the movement barrel 27. Thus, when the rotation of the winding stem 45 is transmitted to the winding pinion 21, the movement barrel 27 is rotated via the wheel row formed by the crown wheel 23, the crown operating wheel 24, the rock wheel 25, and the ratchet wheel 26.

As shown in FIGS. 8 and 9, a mainspring 28 is accommodated in the movement barrel 27. Portion A of a winding-end end portion 28a of the mainspring 28 is welded to a mainspring catch piece member 29. The mainspring catch piece member 29 is caught by a groove 27a open to the peripheral wall inner surface of the movement barrel 27. A winding-start end portion 28b of the mainspring 28 is fixed at the center of the movement barrel 27. The mainspring 28 is constructed such that when the crown 35 described below is rotated, for example, to the right (clockwise), the movement barrel 27 is rotated to the right to thereby wind up the mainspring. FIG. 9 shows a state in which the mainspring 28 has been wound up, and FIG. 8 shows a state in which the mainspring 28 has been rewound. The movement 13 is driven by the force with which the mainspring 28 is rewound.

As shown in FIGS. 2 and 4, a metal winding stem pipe 31 is mounted to the case band 14. The winding stem pipe 31 is inserted into the pipe mounting hole 15 from the outside of the case band 14, and brazed to the case band 14. The winding stem pipe 31 is formed as a cylinder whose axial ends are open, and is equipped with a pipe end portion 31a arranged outside the case band 14. The pipe end portion 31a protrudes sidewise perpendicularly with respect to the lock surface 14c.

The pipe end portion 31a has on the outer peripheral portion thereof a male screw portion 32. The male screw portion 32 is formed by a screw portion having a thread ridge wound in a direction opposite to the winding-up direction of the mainspring 28 so that the one-way clutch 22 may be disengaged (the power transmission may be cut off) with the rotation of the crown 35 to place the crown 35 described below in the lock state. Further, the male screw portion 32 is formed such that when the crown 35 described below is rotated in a direction opposite to the winding-up direction of the mainspring 28, the crown 35 is moved so as to bring an engagement end surface 37a described below into contact with the lock surface 14c. Thus, in this embodiment, the male screw portion 32 is formed, for example, by a left-handed screw.

The metal crown 35 has a crown shaft 36, and a crown head 37 formed by an integral protrusion extending from the central portion of the crown shaft 36. The crown shaft 36 is formed as a round pipe whose forward end is open. Annular waterproof packing 38 formed of an elastic material such as rubber or elastomer is attached to the outer periphery of the forward end portion of the crown shaft 36. Further, a connection ring 39 is fixed to the inner side of the forward end portion of the crown shaft 36. The center hole of the connection ring 39 is a square hole.

The crown head 37 is shorter and of a larger diameter than the crown shaft 36, and a round clearance groove 41 surrounding the outer periphery of the proximal portion of the crown shaft 36 is formed between them. A pipe end portion 31a can be inserted and extracted into and from the clearance groove 41 as the crown 35 is attached and detached to and from the winding stem pipe 31. The crown head 37 has a round engagement end surface 37a continuous with the open end of the clearance groove 41. The engagement end surface 37a is parallel to a plane orthogonal to the axial direction of the crown shaft 36. An outer peripheral surface 37b of the crown head 37 is formed as a knurled asperity surface so that the fingers of the user turning the crown 35 may not be easily allowed to slip thereon.

Further, the crown head 37 has in the inner peripheral portion thereof a female screw portion 42 detachably and threadedly engaged with the male screw portion 32 of the winding stem pipe 31. Like the male screw portion 32, the female screw portion 42 is formed by a screw portion having a thread ridge wound in a direction opposite to the winding-up direction of the mainspring 28 so that the one-way clutch 22 may be disengaged with the rotation of the crown 35 when placing the crown 35 in the lock state. Further, the female screw portion 42 is formed such that when the crown 35 described below is rotated in a direction opposite to the winding-up direction of the mainspring 28, the crown 35 is moved so as to bring the engagement end surface 37a described below into contact with the lock surface 14c. Thus, in this embodiment, as in the case, for example, of the male screw portion 32, the female screw portion 42 is formed as a left-handed screw.

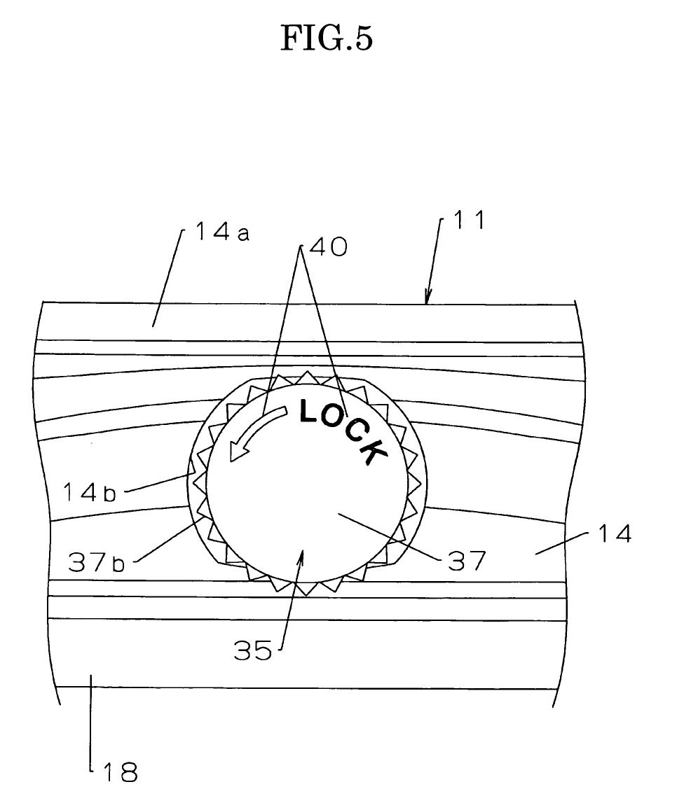

As shown in FIG. 5, a sign 40 is provided on the front surface of the crown head 37. The sign 40 indicates the rotating direction of the crown 35 when placing the crown 35 in the lock state; it consists of an arrow and a row of characters such as “LOCK.”

The crown shaft 36 of the crown 35 is inserted into the winding stem pipe 31 from the outside of the case band 14. Waterproof packing 38 for waterproofness with respect to the in-case-band space 14d is slidalby held in contact with the inner peripheral surface of the winding stem pipe 31. At the same time, the female screw portion 42 of the crown 35 is threadedly engaged with the male screw portion 32 of the winding stem pipe 31, and the crown 35 is detachably mounted to the winding stem pipe 31.

The metal winding stem 45 for transmitting the rotation of the crown 35 or the like to the movement 13 is connected to the crown 35. That is, one end portion of the winding stem 45 arranged inside the in-case-band space 14d is connected to the movement 13, and the other end portion of the winding stem 45 arranged on the crown 35 side is inserted into the crown shaft 36 through a forward end opening thereof. The other end portion of the winding stem 45 is of a square-shaft configuration (not shown) corresponding to the central hole of the connection ring 39, and this square-shaft-shaped portion is slidably inserted into the central hole. Through fit-engagement between the central hole and the other end portion (square-shaft-shaped portion) of the winding stem 45, the rotation of the crown 35 is transmitted to the winding stem 45.

Further, a snap ring 46 arranged inside the crown shaft 36 is mounted to the other end portion of the winding stem 45. The snap ring 46 is held so as to be incapable of moving in the axial direction of the winding stem 45. A coil spring 47 using the snap ring 46 as a spring shoe is accommodated in the crown shaft 36, and the crown 35 is urged away from the lock surface 14c of the case band 14 by the spring force of this coil spring 47.

FIG. 2 shows a state in which the crown 35 is locked so as not to inadvertently rotate in the wristwatch 10 constructed as described above. In this lock state, the female screw portion 42 of the crown 35 is in mesh (threadedly engaged) with the male screw portion 32 of the winding stem pipe 31, and the engagement end surface 37a of the crown 35 is held in contact with the lock surface 14c of the case band 14. Thus, using the lock surface 14c as a stopper, positioning is effected on the crown 35 such that it cannot be further rotated in the direction indicated by the sign 40.

In this lock state, with the insertion depth of the crown shaft 36 with respect to the winding stem pipe 31 being maximum, the coil spring 47 is in a firmly compressed state, and the crown 35 is strongly urged away from the case band 14. In spite of this, the crown 35 is not moved away from the case band 14 through the above-mentioned mesh engagement.

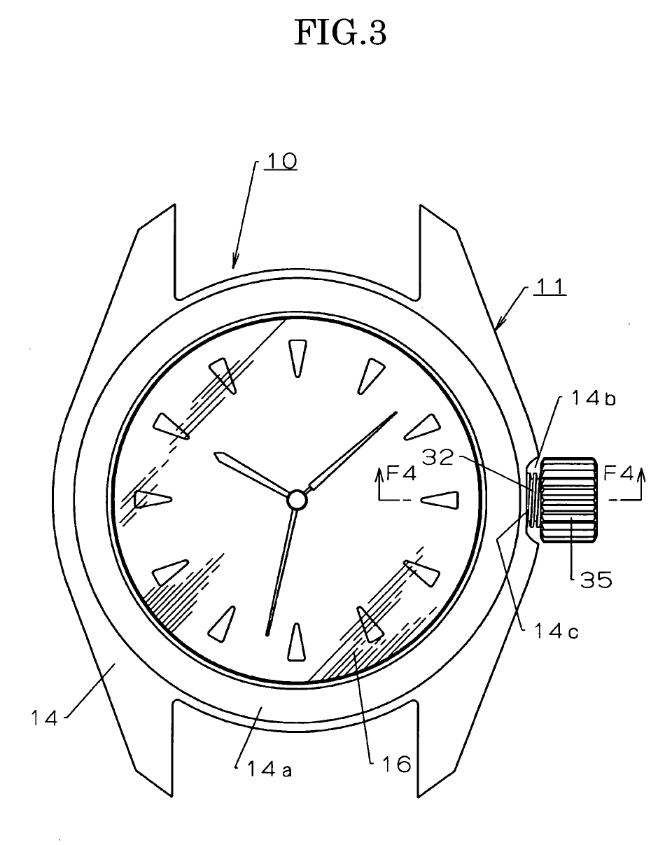

When releasing the lock state of the crown 35, it is only necessary to rotate the crown 35 to the right (clockwise). As a result, the state of engagement between the male screw portion 32 and the female screw portion 42 is changed, and the crown 35 is moved such that the engagement end surface 37a is moved away from the lock surface 14c of the case band 14, so that the lock state is released, and, soon, the mesh engagement of the female screw portion 42 with the male screw portion 32 is released. At the same time, due to the spring force of the coil spring 47, the crown 35 is pushed out until the connection ring 39 abuts the snap ring 46. FIGS. 3 and 4 show this lock-released state.

As described above, with the lock being released and the crown 35 pushed out, that is, in the “0th step” state, the crown 35 is continuously rotated to the right (clockwise), whereby it is possible to wind up the mainspring 28 of the movement 13. In this case, the crown 35 is rotated such that the one-way clutch 22 of the movement 13 is “engaged,” or, in other words, placed in the connected state, so that the rotation of the crown 35 is transmitted to the movement 13 via the winding stem 45, and the mainspring 28 is wound up.

As described above, the rotating direction of the crown 35 when releasing the lock state of the crown 35 and the rotating direction of the crown 35 when winding up the mainspring 28 subsequent thereto are the same. Thus, when releasing the lock state of the crown 35 and winding up the mainspring 28, there is no need to check whether the lock state of the crown 35 has been released or not, and there is no need to take the trouble to rotate the crown 35 in the reverse direction based on this checking.

That is, through the easy operation of simply continuing the rotation to release the lock state of the crown 35 even after the lock state has been released, it is possible to successively perform the releasing of the lock state of the crown 35 and the winding-up of the mainspring 28 without having to mind the rotating direction, etc. of the crown 35. When thus releasing the lock state of the crown 35 and winding up the mainspring 28, the rotating direction of the crown 35 remains the same, and it is only necessary to continuously rotate the crown 35, so that it is possible to improve the operability of the crown 35. It is possible to perceive the completion of the winding-up of the mainspring 28 as the rotation of the crown 35 becomes heavier due to the load of the mainspring 28 abruptly increased through the winding-up of the mainspring 28.

Further, when performing date setting in the state of FIGS. 3 and 4, in which the winding-up of the mainspring 28 is possible, the crown 35 is pulled further away from the lock surface 14c, and is arranged at the date setting position, that is, the “1st step” position, and then the crown 35 is rotated. Further, when performing time setting, the crown 35 is further pulled from the “1st step” position to the time setting position, that is, the “2nd step” position, and then the crown 35 is rotated, thereby making it possible to effect time setting.

When the crown 35 is arranged at one of these two positions, the engagement of the one-way clutch 22 is released (in other words, the one-way clutch 22 is disengaged), so that the mainspring 28 does not constitute a load in rotating the crown 35 for date setting or time setting.

To restore the crown 35 to the lock state after each of the above operations, the crown 35 is pushed back toward the case band 14 side against the coil spring 47, and then the crown 35 is rotated to threadedly engage the female screw portion 42 thereof with the male screw portion 32 of the winding stem pipe 31. In this case, the crown 35 is rotated according to the sign 40 of the crown head 37. As a result, in placing the crown 35 in the lock state, it is possible to suppress an error in the rotating direction of the crown 35.

When restoring the crown 35 to the lock state by the above procedures, the crown 35 is rotated in a direction opposite to the winding-up direction of the mainspring 28. More specifically, the crown 35 is rotated to the left. Through the resultant change in the mesh engagement between the female screw portion 42 and the male screw portion 32, the crown 35 is moved toward the lock surface 14c of the case band 14, and, soon, the engagement end surface 37a of the crown 35 abuts the lock surface 14c. Thus, through this contact, it is possible to maintain the crown 35 in the lock state so that the crown 35 may not be unnecessarily rotated while, for example, the wristwatch 10 is being carried about.

When thus placing the crown 35 in the lock state, the crown 35 is rotated, as described above, in a direction opposite to the winding-up direction of the mainspring 28, and, at the same time, the winding stem 45 is rotated in the same direction as the crown 35. The rotating direction of the winding stem 45 at this time is such that the one-way clutch 22 is placed in the “disengaged” state, so that the driving side clutch member 22a of the one-way clutch 22 idles on the receiving side clutch member 22b so as to slip thereon. As a result, the rotation of the crown 35 rotated to the left so as to rewind the mainspring 28 is not transmitted to the winding pinion 21 via the one-way clutch 22.

When thus placing the crown 35 in the lock state, the crown 35 and the mainspring 28 are not connected to each other via the winding stem 45 and the one-way clutch 22, so that the mainspring 28 does not constitute a load with respect to the rotation of the crown 35. Thus, even in the state in which the mainspring 28 has been sufficiently wound up, the rotating operation of the crown 35 when placing the crown 35 in the lock state does not become heavier due to the mainspring 28. In this way, it is possible to attain the lock state through rotation of the crown 35 without receiving the winding-up load of the mainspring 28, so that it is possible to improve the operability of the crown 35.

Further, in the portable timepiece 10 constructed as described above, by utilizing the one-way clutch 22 of the movement 13 as described above, it is possible to perform the rotation of the crown 35 when placing the crown 35 without receiving the winding-up load of the mainspring 28. Thus, there is no need to provide a dedicated clutch for preventing reception of the winding-up load of the mainspring 28 when maintaining the lock state through rotation of the crown 35. That is, there is no need, as in the prior art, to contrive to divide the crown into the crown head and the crown shaft and to provide therebetween a dog clutch on the inner side of the crown head 37, and the crown shaft 36 and the crown head 37 can be integrated to form the crown 35, so that it is possible to achieve a simple construction for the crown 35 and to prevent an increase in the thickness of the crown head 37 of the crown 35.

Further, in this embodiment, the mainspring 28 is wound up when the crown 35 is rotated to the right, and the crown 35 is arranged in the lock state when the crown 35 is rotated to the left. Thus, to wind up the mainspring 28, the crown 35 is rotated to the right in the same crown rotating direction as in an ordinary windup portable timepiece, so that there is involved no sense of incongruity in the operation of winding up the mainspring 28. At the same time, the lock state of the crown 35 can be realized by rotating the crown 35 to the left. Thus, by forming the male screw portion 32 and the female screw portion 42 so as to enable such rotating operation, the construction of the other portions such as the movement 13 may be the same as that in the prior art, which means the embodiment can be easily carried out.

In the above embodiment, when the crown 35 is rotated to the right, the lock state of the crown 35 is released, and the mainspring 28 is wound up; conversely, when the crown 35 is rotated to the left, the crown 35 is threadedly engaged in the lock state, and the one-way clutch 22 is disengaged so that the rotation of the crown 35 may not be transmitted to the mainspring 28; however, it is also possible for the present invention to be carried out in a fashion reverse to the above. That is, the present invention can also be carried out through a construction in which when the crown 35 is rotated to the left, the lock state of the crown 35 is released, and the mainspring 28 is wound up; when, conversely, the crown 35 is rotated to the right, the crown 35 is threadedly engaged in the lock state, and the one-way clutch 22 is disengaged so that the rotation of the crown 35 may not be transmitted to the mainspring 28.

The present invention can also be applied to a portable timepiece other than a wristwatch, for example, a pocket watch.

What is claimed is:

1. A portable timepiece comprising:
a movement having a mainspring, and a one-way clutch which transmits rotation to wind up this mainspring to the mainspring and which operates so as to prevent rotation to rewind the mainspring from being transmitted to the mainspring;
a winding stem transmitting rotation to this movement;
a timepiece exterior assembly having a case band with a lock surface formed in an outer peripheral portion thereof and containing the movement and the winding stem;
a winding stem pipe having a male screw portion arranged outside the case band and fixed to the case band; and
a crown which has a crown head arranged outside the case band, the crown head having a female screw portion detachably and threadedly engaged with the male screw portion and an engagement end surface moving toward and away from the lock surface, and which is rotated in a direction opposite to the direction in which the mainspring is wound up when bringing the engagement end surface into contact with the lock surface to maintain a lock state, and is rotated in the same direction as the direction in which the mainspring is wound up when releasing the lock state and winding up the mainspring.

2. A portable timepiece according to claim 1, characterized in that the male screw portion and the female screw portion are formed such that when the crown is rotated in a direction opposite to the direction in which the mainspring is wound up, the crown is moved so as to bring the engagement end surface into contact with the lock surface.

3. A portable timepiece according to claim 1, characterized in that the mainspring is wound up when the crown is rotated to the right, and that the crown is arranged in the lock state when the crown is rotated to the left.

4. A portable timepiece according to claim 1, characterized in that a sign indicating the rotating direction of the crown when placing the crown in the lock state is provided on a front side of a crown head.

5. A method of operating a crown for a portable timepiece equipped with: a movement having a mainspring, and a one-way clutch which transmits rotation to wind up this mainspring to the mainspring and which operates so as to prevent rotation to rewind the mainspring from being transmitted to the mainspring;
a winding stem transmitting rotation to this movement;
a timepiece exterior assembly having a case band with a lock surface formed in an outer peripheral portion thereof and containing the winding stem;
a winding stem pipe having a male screw portion arranged outside the case band and fixed to the case band; and
a crown which has a crown head arranged outside the case band and having a female screw portion detachably and threadedly engaged with the male screw portion and an engagement end surface moving toward and away from the lock surface, and which is maintained in a lock state by bringing the engagement end surface into contact with the lock surface,
characterized in that, when placing the crown in the lock state, the crown is rotated in a direction opposite to the direction in which the mainspring is wound up, and that, when winding up the mainspring from the lock state, the crown is rotated in the same direction as the winding-up direction of the mainspring to release the lock, and continue, subsequent to this releasing, the rotation of the crown in the same direction.
